(19) United States
(12) Patent Application Publication
(10) Pub. No.: US 2006/0226800 A1
(43) Pub. Date: Oct. 12, 2006

(54) Scrolling backlight device for lcd display panel

(75) Inventor: Gert W. Bruning, Sleepy Hollow, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/545,545

(22) PCT Filed: Dec. 11, 2003
(86) PCT No.: PCT/IB03/05908

§ 371 Date: Aug. 12, 2005

Related U.S. Application Data
(60) Provisional application No. 60/434,564, filed on Dec. 18, 2002.

(51) Int. Cl. H02P 1/00

(52) U.S. Cl. 318/280

(57) ABSTRACT

A scrolling backlight device includes a plurality of light guides, a power supply adapted to supply an output voltage, a plurality of microlight engines each adapted to provide light to one of the light guides when supplied with the output voltage; and a plurality of switches adapted to selectively connect the power signal to the microlight engines to sequentially provide light to the plurality of light guides. The horizontally-extending light guides are arranged side by side in the vertical direction. A controller sequentially activates the microlight engines to sequentially illuminate the light guides from top to bottom of the device in a repeating scrolling pattern. The microlight engines include an electronic light source such as a light emitting diode.

This invention pertains to the field of backlights, and more particularly, to a scrolling backlight that is well adapted for use with a liquid crystal display, such as a liquid crystal display for displaying television or other motion-video images.

Backlight devices are commonly used in conjunction with various video display devices, including particularly liquid crystal display (LCD) devices such as thin-film-transistor LCDs (TFT-LCDs). Such a backlight device can substantially increase the visibility of the display.

Meanwhile, motion artifacts are a common problem with some types of displays, such as LCDs. Motion artifacts occur when certain display devices attempt to display video information that represents rapidly changing pictures, such as fast-moving objects or people (e.g., athletic events, etc.). Such motion artifacts may occur in particular in an LCD device that displays television or other motion-video images, such an LCD TV receiver or monitor.

Various techniques have been proposed to mitigate the perceptibility of such motion artifacts. One technique for mitigating the perceptibility of motion artifacts is to employ a scrolling backlight device.

Accordingly, a display device prone to motion artifacts, for example an LCD device that displays television or other motion-video images (such as an LCD TV receiver or monitor), may be supplied with a scrolling backlight device.

Typically, such a scrolling backlight device includes a plurality of cold cathode flourescent lamps (CCFLs) directly behind the display, vertically juxtaposed and extending horizontally across a visible width of the display. For example, a scrolling backlight device for a 15″ LCD device might include a set of 6-8 horizontally-extending CCFLs, the CCFLs being vertically juxtaposed (lying side by side) across the back side of the LCD. The operation of such a scrolling backlight device will now be explained in conjunction with an exemplary LCD device.

As is well known, a typical LCD has several hundred (e.g., 1200) horizontal lines or rows, and each row includes a plurality of pixels (e.g., 1600 pixels) arranged in a corresponding number of columns. To show an image on such a display, a video signal is vertically scanned on a row-by-row basis from the top to the bottom of the display. That is, during a video frame, each row of pixels is activated sequentially from the top to the bottom of the display to write video data into the plurality of pixels in that row. After writing the video data into all the pixels of a row during one horizontal line interval, the row is deactivated and the pixels in that row store the video data until the next frame, while new video data is sequentially written into the remainder of the rows of the display.

To mitigate the effects of motion artifacts, the LCD device may include a scrolling backlight device that typically operates such that only one of the plurality of vertically-juxtaposed CCFLs is illuminated at any one time. For example, the topmost CCFL may be illuminated first for a brief period of time. Then, the topmost CCFL is turned off, while at the same time the next topmost CCFL immediately beneath the topmost CCFL is turned on. The next topmost CCFL remains on for the same brief period of time, before it too is turned off and, in its place, the CCFL beneath it is turned on, and so on from the top to the bottom of the device. After the bottom-most CCFL is illuminated for the same brief time period, it too is turned off, while at the same time the topmost CCFL is turned on again to repeat the pattern. This produces a scrolling effect wherein the light from the scrolling backlight device scrolls from top to bottom behind the display.

Accordingly, with such a scrolling backlight device, only a fraction (e.g., one-eighth) of the rows of pixels of the LCD are illuminated at any one time. Because the scroll rate of the scrolling backlight device is set faster than a response time for human vision (e.g., scrolling through the entire set of CCFLs 30 times per second), the scrolling effect itself is not visually perceptible to the human eye. At the same time, however, the scrolling illumination of the display lines also serves to mitigate the perceptibility of motion artifacts in the display.

Unfortunately, there are problems with such scrolling backlight devices. First, to turn on a CCFL it first must be ignited, then after a delay period the light intensity ramps up to a desired brightness level. Accordingly, the response time of a CCFL is typically slow (e.g., 1-10 msec.). This makes it difficult to produce a desirably fast scroll rate. Second, the CCFLs represent a substantial heat source located directly behind the display. Such heat may degrade the performance and/or reliability of the display. Third, the CCFLs disposed behind the display produce electromagnetic radiation that can interfere with the proper operation of the display. Accordingly, electromagnetic interference (EMI) shielding is typically employed. Such EMI shields undesirably add cost, weight, bulkiness, and complexity to the display device. Fourth, a CCFL requires a high voltage supply that does not facilitate switching of the power supply output. Therefore, each CCFL generally requires its own separately regulated power inverter. For example, a CCFL-based scrolling backlight for a 15″ LCD device may require 6-8 power inverters. Again, this undesirably adds cost, weight, bulkiness, and complexity to the display device.

Accordingly, it would be desirable to provide an improved scrolling backlight device, and in particular, a scrolling backlight device capable of operating at a faster scroll rate. It would also be desirable to provide a scrolling backlight device that produces less heat directly behind the display. It would be further desirable to provide a scrolling backlight device that produces less EMI radiation directly behind the display. It would be still further desirable to provide a scrolling backlight device that eliminates the need for a large number of power inverters. The present invention is directed to addressing one or more of the preceding concerns.

In one aspect of the invention, a scrolling backlight device comprises: a plurality of light guides juxtaposed along a first direction, each of the light guides extending lengthwise in a second direction substantially perpendicular to the first direction; a power supply adapted to supply an output voltage; a plurality of microlight engines, each said microlight engine comprising an electronic light source adapted to produce light when the microlight engine is supplied with the output voltage, and an optical coupling device adapted to couple light produced by the light emitting diode into an end of a corresponding one of the light guides; a plurality of switches adapted to selectively connect the output voltage to the microlight engines; and control means adapted to control the plurality of switches to sequentially connect the output voltage to each of the microlight engines, in response to which the microlight engines sequentially provide light to the plurality of light-guides.

In another aspect of the invention, a scrolling backlight device comprises: a plurality of light guides; a power supply adapted to supply an output voltage; a plurality of microlight engines each adapted to provide light to one of the light guides when supplied with the output voltage; and a plurality of switches adapted to selectively connect the output voltage to the micro-light engines to sequentially provide light to the plurality of light guides.

In yet another aspect of the invention, a scrolling backlight device comprises: a plurality of light guides; a plurality of electronic light sources each adapted to produce light; and means for sequentially providing the light from the electronic light sources to the plurality of light guides.

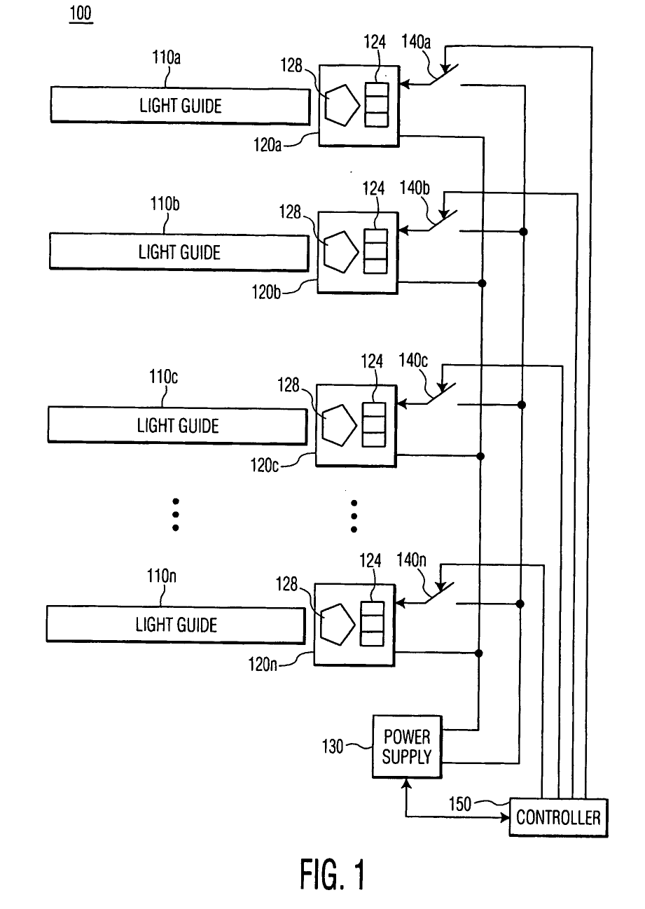

FIG. 1 shows a first embodiment of a scrolling backlight device according to one or more aspects of the invention;

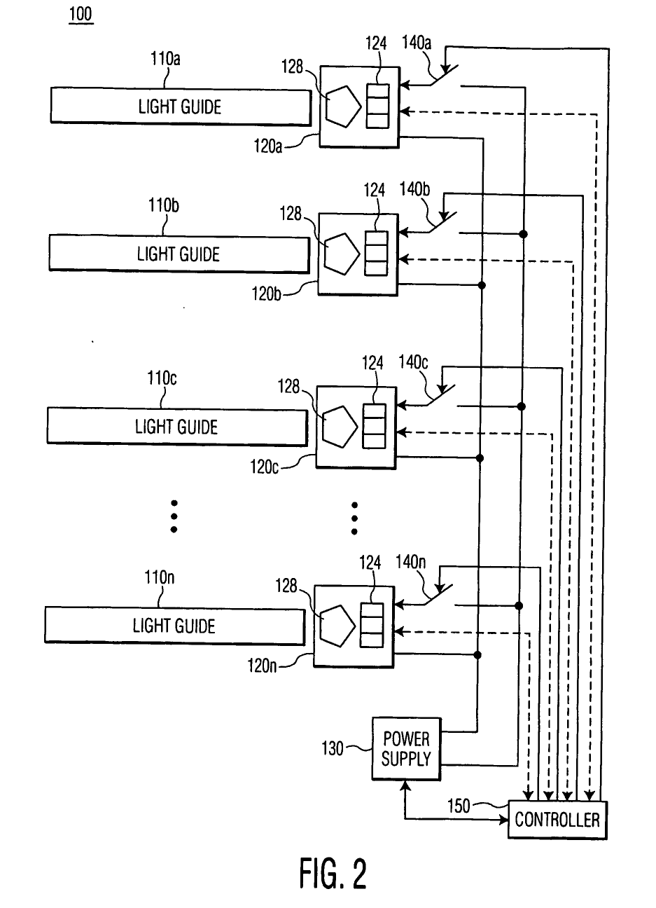

FIG. 2 shows a second embodiment of a scrolling backlight device according to one or more aspects of the invention.

FIG. 1 shows an embodiment of a scrolling backlight device 100 according to one or more aspects of the invention. The scrolling backlight device 100 includes: a plurality of light guides 110, a plurality of microlight engines 120, a power supply 130, a plurality of switches 140; and a controller 150.

As shown in FIG. 1, each light guide 110 extends lengthwise in a first (e.g., horizontal) direction. Meanwhile, the light guides 110 are juxtaposed (lie side by side) along a second (vertical) direction.

In the embodiment illustrated in FIG. 1, there is a one-to-one correspondence between the plurality of light guides 110 and the plurality of microlight engines 120. Alternatively, each light guide 110 may have a corresponding pair of microlight engines 120 adapted to couple light into the two opposite ends of the light guide 110.

As shown in FIG. 1, a first terminal of each of the plurality of switches 140 is connected to a power input terminal of one of the plurality of microlight engines 120, and a second terminal of each switch 140 is connected to a power supply output terminal of the power supply 130. The control terminals of the switches 140 are connected to output lines of the controller 150.

Beneficially, each switch 140 may be an electronic switch, such as a transistor, and particularly a field effect transistor. In such a case, the switching speed may be significantly faster than if a mechanical or electromechanical switch was employed. Also, although the embodiment of FIG. 1 shows a plurality of single-pole, single-throw switches connected between the plurality of microlight engines 120 and the power supply output terminal, it would be understood that one single-pole, multi-throw switch could be used instead, with appropriate adjustment to the output(s) of the controller 150.

Beneficially, the power supply 130 is a current source providing a desired current to the power supply output terminal. Further beneficially, the power supply outputs to the power supply output terminal a power signal comprising a pulse width modulated (PWM) voltage waveform. By accurately controlling the duty cycle/pulse width of the PWM voltage, the power supply 130 can provide an accurately controlled current to the power supply output terminal.

Each microlight engine 120 comprises an electronic light source 124 and an optical coupling device 128.

Beneficially, the electronic light source 124 may include a white-light producing phosphor light emitting diode (LED), such as a blue LED with yellow phosphor or a UV LED with tricolor (e.g., red, green, and blue—RGB) phosphor, or a set of three (e.g., RGB) LEDs. Other similar arrangements are possible. Each microlight engine 120 may include additional LEDs or LED-combinations, as necessary, to produce light having a desired intensity. Beneficially, high-brightness (e.g., 5 watt) LEDs are employed. Advantageously, an LED turns on much more rapidly than a CCFL (e.g., <100 nsec.) and operates with a relatively low voltage supply (e.g. ≦15 volts).

Beneficially, the scrolling backlight device 100 may be included in a display device, such as a liquid crystal display (LCD) device. A scrolling backlight device for a 15″ LCD device might include a set of 6-8 horizontally-extending light guides 110, the light guides 110 being vertically juxtaposed, and beneficially, generally linearly spaced apart. The scrolling backlight device 100 may be disposed behind the LCD with respect to a viewing direction of the device.

An explanation of the operation of scrolling backlight device 100 will now be provided.

The power supply 130 provides a power signal, that may be a fixed or variable current supply, to the power supply output terminal connected to one end of each switch 140. The open/closed state of each switch 140 is determined by a signal supplied to the corresponding control terminal by the controller 150. When a switch 140 is closed by the controller 150, the power supply output terminal is connected to a power input terminal of a corresponding microlight engine 120. When the power input terminal of a microlight engine 120 is connected to the power supply output terminal, then a power signal (e.g., current supply) is supplied to the electronic light source 124 of that microlight engine 120. In response to the power signal, the electronic light source 124 produces light. In one embodiment, microlight engine 120 comprises one or more LEDs that are turned on to produce light in response to the power signal (e.g., current supply). Beneficially, in contrast to the undesirably slow response time of a CCFL, the response time of the electronic light source 124 (and therefor of the microlight engine 120) is quite fast (e.g., <100 nsec.).

Light produced by the electronic light source 124 is supplied to the coupling device 128. The coupling device 128 then couples the light into an end of a corresponding one of the light guides 110.

In the case where there are two microlight engines 120 for each light guide 110, then, when a switch 140 is closed by the controller 150, the power supply output terminal of the power supply 130 is connected to the power input terminals of two corresponding microlight engines 120, such that electronic light sources 124 in both microlight engines 120 produce light. The coupling devices 128 of the two microlight engines 120 couple the light into corresponding opposite ends of the one of the light guides 110.

Thus, when one of the switches 140 is closed, a corresponding one of the light guides 110 is illuminated by light from one or more corresponding microlight engines 120. Accordingly, by properly controlling the sequence and timing by which the switches 140 are closed, the controller 150 can achieve the scrolling effect.

An explanation of the scrolling operation of the scrolling backlight device 100 will now be provided.

First, the controller 150 closes a switch 140a associated with a topmost light guide 110a. In response, the topmost light guide 110a is illuminated for a brief period of time (e.g., 2 ms). Then, the controller 150 opens the switch 140a while, at or about the same time, closing the switch 140b. In response, the topmost light guide 110a is turned off or deluminated, while at or about the same time the next topmost light guide 110b immediately beneath the topmost light guide 110a is illuminated. The light guide 110b remains illuminated for about the same brief period of time as the topmost light guide 110a, before it too is turned off or deluminated, and in its place, the light guide 110c beneath it is illuminated, and so on, etc., etc. This produces an effect wherein the light from the scrolling backlight device scrolls from the top to the bottom of the device. After the bottom-most light guide 110n is illuminated for about the same brief time period, then it too is turned off, while at about the same time the topmost light guide 110a is illuminated again to repeat the pattern.

In general, the spectral purity of the light produced by the scrolling backlight device 100 is important, so as not to undesirably affect the color fidelity of a display device in which it is employed. Similarly, it is important that color of the light produced by the scrolling backlight device 100 does not perceptibly change color or intensity as the light scrolls from top to bottom. Accordingly, the light produced by each microlight engine 120 is controlled to fall in a very tight illumination band. Beneficially, characteristics of the light from each microlight engine 120 may be adjusted by means of varying the current level of the power signal provided by the power supply 130. In that case, as shown in FIG. 1, a control signal may be supplied from the controller 150 to the power supply 130 to adjust the current level of the power signal provided to the power supply output terminal, in synchronism with the signals connecting and disconnecting the switches 140 for each corresponding microlight engine 120. For example, when the power signal comprises a pulse width modulated (PWM) voltage waveform, the current level may be adjusted by varying the duty cycle (pulse width) of the PWM waveform.

For example, a calibration process may be performed to determine a desired current value for the power signal supplied to each microlight engine 120 to achieve the light color and intensity-matching objectives mentioned above. Then, data may be stored in the controller to produce the desired power supply output voltage levels.

Beneficially, in a second embodiment shown in FIG. 2, the color point and intensity of the light output of each microlight engine 120 may be controlled by the controller 150 in conjunction with the power supply 130. In that case, a signal may be provided from each the controller 150 to each microlight engine 120 to indicate a reference color point and intensity that is to be obtained. Meanwhile, as shown in FIG. 2, a feedback signal from the microlight engine 120 to the controller 150 may indicate the actual color point and intensity of the light being produced by the microlight engine 120. In response to this information, the controller 150 controls the power supply 130 to increase or decrease the current level of the power signal to achieve the desired color point and intensity. For example, when the power signal comprises a pulse width modulated (PWM) voltage waveform, the current level may be adjusted by varying the duty cycle (pulse width) of the PWM waveform.

In the scrolling backlight device 100, the microlight engines 120 may be located at one or both horizontal ends of the device, or a similar convenient location. Beneficially, when the scrolling backlight device 100 is employed in a display device, such as an LCD display, this removes a heat source from being located directly behind the display panel, as is the case with the CCFL-based scrolling backlight device discussed above. Similarly, the scrolling backlight device 100 does not generate the large amount of EMI directly behind the display, and therefore it is possible to eliminate the EMI shields that are included in the CCFL-based scrolling backlight device. Furthermore, the scrolling backlight device 100 operates with a single power supply 130 and does not require the numerous power inverters that are required by the CCFL-based scrolling backlight device.

While preferred embodiments are disclosed herein, many variations are possible which remain within the concept and scope of the invention. For example, in some configurations, the power supply and/or the controller may be located externally to the scrolling backlight device. Such variations would become clear to one of ordinary skill in the art after inspection of the specification, drawings and claims herein. The invention therefore is not to be restricted except within the spirit and scope of the appended claims.

1. A scrolling backlight device, comprising:
a plurality of light guides juxtaposed along a first direction, each of the light guides extending lengthwise in a second direction substantially perpendicular to the first direction;
a power supply adapted to supply a power signal;
a plurality of microlight engines, each said microlight engine comprising
an electronic light source adapted to produce light when the microlight engine is supplied with the power signal, and
an optical coupling device adapted to couple light produced by the electronic light source into an end of a corresponding one of the light guides;
a plurality of switches adapted to selectively connect the power signal to the microlight engines; and
control means adapted to control the plurality of switches to sequentially connect the power signal to each of the microlight engines, in response to which the microlight engines sequentially provide light to the plurality of light-guides.

2. The scrolling backlight device of claim 1, further comprising a plurality of second microlight engines, each of the second microlight engines comprising:
an electronic light source adapted to produce light when the microlight engine is supplied with the power signal; and
an optical coupling device adapted to couple light produced by the electronic light source into a second end of a corresponding one of the light guides.

3. The scrolling backlight device of claim 1, wherein the electronic light source comprises a light emitting diode.

4. The scrolling backlight device of claim 1, wherein the electronic light source comprises:
a first light emitting diode (LED) producing red light;
a second light emitting diode (LED) producing green light;
a third light emitting diode (LED) producing blue light.

5. The scrolling backlight device of claim 1, wherein the electronic light source comprises a blue light emitting diode (LED) covered with yellow phosphor.

6. A scrolling backlight device, comprising:
a plurality of light guides;
a power supply adapted to supply a power signal;
a plurality of microlight engines each adapted to provide light to one of the light guides when supplied with the power signal; and
a plurality of switches adapted to selectively connect the power signal to the micro-light engines to sequentially provide light to the plurality of light guides.

7. The scrolling backlight device of claim 6, wherein each of the microlight engines includes a light emitting diode (LED).

8. The scrolling backlight device of claim 6, wherein each of the microlight engines comprises:
a first light emitting diode (LED) producing red light;
a second light emitting diode (LED) producing green light;
a third light emitting diode (LED) producing blue light.

9. The scrolling backlight device of claim 6, wherein the light guides each extend in a horizontal direction and are linearly spaced apart in a vertical direction.

10. The scrolling backlight device of claim 9, further comprising means for controlling the plurality of switches to illuminate the light guides sequentially in the vertical direction from top to bottom.

11. The scrolling backlight device of claim 6, wherein each of the plurality of switches comprises a transistor.

12. The scrolling backlight device of claim 6, wherein each of the plurality of microlight engines is disposed at a horizontal end of a corresponding one of the plurality of light guides.

13. The scrolling backlight device of claim 6, wherein there are twice as many microlight engines as there are light guides, and wherein each of the plurality of microlight engines is disposed at a horizontal end of one of the plurality of light guides.

14. A scrolling backlight device, comprising:
a plurality of light guides;
a plurality of electronic light sources each adapted to produce light; and
means for sequentially providing the light from the electronic light sources to the plurality of light guides.

15. The scrolling backlight device of claim 14, wherein each of the electronic light sources comprises a light emitting diode.

16. The scrolling backlight device of claim 14, wherein each electronic light source comprises:
a first light emitting diode (LED) producing red light;
a second light emitting diode (LED) producing green light;
a third light emitting diode (LED) producing blue light.

17. The scrolling backlight device of claim 14, wherein each electronic light source comprises a blue light emitting diode (LED) covered with yellow phosphor.

18. The scrolling backlight device of claim 14, wherein the means for sequentially providing the light from the electronic light sources to the plurality of light guides, comprises:
means for selectively activating and deactivating the electronic light sources; and
optical couplers adapted to couple the light from the electronic light sources to the plurality of light guides.

19. The scrolling backlight device of claim 18, wherein the means for selectively activating and deactivating the electronic light sources comprises a plurality of transistors selectively providing a power signal to the electronic light sources.

20. The scrolling backlight device of claim 19, further comprising a controller controlling a connection/disconnection state of the plurality of transistors to selectively provide the power signal to the electronic light sources.
